(19) United States
(12) Patent Application Publication
(10) Pub. No.: US 2008/0229568 A1
(43) Pub. Date: Sep. 25, 2008

(54) Method for assembling a semi-trailer

(76) Inventor: Lawrence J. Gross, Port Washington, NY (US)

Correspondence Address: COLLARD & ROE, P.C., 1077 NORTHERN BOULEVARD, ROSLYN, NY, 11576, US

(21) Appl. No.: 11/726,222

(22) Filed: Mar. 21, 2007

(51) Int. Cl. B21D 39/00; B60P 1/64; B62D 53/06

(52) U.S. Cl. 29/430; 280/423.1; 410/82

(57) ABSTRACT

A semi-trailer is assembled by constructing a semi-trailer body at a remote location. The semi-trailer body is transported from the remote location to an originating port by highway or rail and loaded onto a vessel by lifting the semi-trailer body using a plurality of upper female ISO connection points. The semi-trailer body is arranged in a stacked configuration on the vessel using the upper female ISO connection points and vertical load carrying members. The semi-trailer body is unloaded from the vessel at a destination port and a running gear assembly, a landing gear assembly, and a rear under-ride guard are attached to form an assembled semi-trailer.

### BACKGROUND OF THE INVENTION

1. Field of the Invention

The invention relates to methods for assembling a semi-trailer. More particularly, the invention relates to methods for assembling a semi-trailer from a semi-trailer kit including a semi-trailer body adapted to be transported and arranged on a vessel in the manner of a shipping container.

2. The Prior Art

Various types of semi-trailers for transporting cargo are known. Semi-trailers are configured to be coupled to a tractor which provides the power for moving the semi-trailer. Semi-trailers vary in size according to application and applicable regulatory restrictions. For example, a typical semi-trailer for use in North America may measure approximately fifty three feet long, approximately one hundred two inches wide with an overall height of approximately thirteen feet six inches and a box exterior height of approximately one hundred sixteen to one hundred eighteen inches.

The following references, the disclosures of which are hereby incorporated herein by reference, relate to semi-trailers.

U.S. Pat. No. 6,471,233 to Stragier shows a method for converting a refuse collection body into a semi-trailer. U.S. Pat. No. 6,439,131 to Higgins shows a truck trailer which is convertible between highway and railway use. U.S. Pat. No. 4,562,633 to Adams et al. shows a railway flatcar for piggyback carloading (mounting and shipping a highway trailer).

It is also known to move cargo internationally using shipping containers or freight containers. These containers incorporate strong vertical load bearing members to allow vertical stacking of the containers during transport on a vessel, for example an ocean-going container ship.

Containers typically include top and bottom connection points or castings to permit interlocking of the stacked containers. These connection points, along with the vertical support members are typically spaced approximately forty feet apart. The upper connection points or castings are typically used as the primary lifting points for loading and unloading the container from a vessel. Additionally, containers may be loaded on a skeletal chassis known as a container chassis for highway movement.

The following references, the disclosures of which are hereby incorporated herein by reference, relate various types of shipping containers.

U.S. Pat. No. 5,816,423 to Fenton et al. shows an intermodal shipping container having an arrangement of lock receiving connectors and stacking points configured so that the container can be stacked and transported with other containers of various sizes. U.S. Pat. No. 4,844,672 to Yurgevich shows a wide-body shipping container which is adopted for engagement with standard-width container supports found on truck trailer chassis, railway flat cars, barges and ships.

U.S. Pat. No. 5,449,082 to Reynard shows a non-standard (non-ISO) cargo container provided with lift fittings which are arranged so that the non-standard length container can be lifted with marine cranes designed to lift ISO containers. U.S. Patent Application Publication No. 2004/0188433 to Morales et al. shows an industrial transport cargo container for transporting heavy equipment from a land base to an offshore, marine structure, such as an oil rig or platform.

International or ISO (International Standard Organization) containers may measure approximately forty feet long and ninety six inches wide and may be stacked nine containers high on a vessel. “Domestic containers” with dimensions more closely approximating the dimensions of a semi-trailer (for example approximately fifty three feet long and one hundred two inches wide) are also known.

Such domestic containers can be used to transport cargo by rail, and are typically not as strong as the ISO containers. For example, domestic trailers may be designed to be stacked only two or three containers high. In order to allow for the stacking of domestic containers on specially designed rail cars, their exterior height is limited and compromises are made with respect to their interior dimensions and floor structure. The domestic containers may include vertical load carrying members and connection points or castings spaced approximately forty feet apart so that the domestic containers can be lifted and moved using the same equipment used for ISO containers.

Semi-trailers are generally built in domestic trailer manufacturing facilities. Prior to a method according to an embodiment of the invention, it has not been economical or feasible to transport multiple semi-trailers or semi-trailer bodies on a vessel in the manner of a container. Thus, it has not been possible for domestic entities to source or import semi-trailers or semi-trailer bodies from overseas manufacturers in order to obtain the cost advantages associated with overseas manufacturing.

Accordingly, a need exists for a method for assembling a semi-trailer, wherein a semi-trailer body may be constructed at or sourced from a remote location, and then transported on a vessel for assembly into a finished semi-trailer. Moreover, a need exists for a method for assembling a semi-trailer wherein a semi-trailer body may be lifted, stacked, and/or transported using existing standard equipment and methods used for shipping containers. A need further exists for a method for assembling a semi-trailer wherein various components are added to and/or removed from the semi-trailer body after the semi-trailer body has been transported on a vessel from a remote location to a destination location.

### SUMMARY OF THE INVENTION

The invention relates to methods for assembling a semi-trailer. More particularly, the invention relates to methods for assembling a semi-trailer from a semi-trailer kit including a semi-trailer body adapted to be arranged and transported on a vessel in the manner of a shipping container.

In a method according to an embodiment of the invention, a semi-trailer is assembled by constructing a semi-trailer body at a remote location. The semi-trailer body is transported from the remote location to an originating port by highway or rail and loaded onto a vessel at the originating port by lifting the semi-trailer body using a plurality of upper female ISO connection points. The semi-trailer body is arranged in a stacked configuration on the vessel using the plurality of upper female ISO connection points and a plurality of vertical load carrying members.

The semi-trailer body is unloaded from the vessel at a destination port by lifting the semi-trailer body using the plurality of upper female ISO connection points. A running gear assembly, a landing gear assembly, and a rear under-ride guard are attached to the semi-trailer body to form an assembled semi-trailer.

In a method according to a further embodiment of the invention, a semi-trailer kit is sourced from a remote location. The semi-trailer kit includes a semi-trailer body, a plurality of upper female ISO connection points and a plurality of vertical load carrying members.

The semi-trailer body is lifted from a vessel at a destination port using the plurality of upper female ISO connection points. A running gear assembly, a landing gear assembly and a rear under-ride guard are attached to the semi-trailer body to form an assembled semi-trailer.

An advantage of a method of assembling a semi-trailer according to an embodiment of the invention is that significant cost savings can be achieved by sourcing or importing a semi-trailer body from an overseas manufacturer. A further advantage of a method of assembling a semi-trailer according to an embodiment of the invention is that a semi-trailer body is provided which can be readily loaded, unloaded, arranged, transported and otherwise handled in the manner of a standard shipping container, using existing equipment and methods.

A further advantage of a method for assembling a semi-trailer according to an embodiment of the invention is that components required for lifting and stacking the semi-trailer body may be adapted to be removed from the semi-trailer body when no longer needed. These components can be returned to the manufacturer for re-use with another semi-trailer body. Additionally, some or all of the components required to be added to the semi-trailer body to complete the semi-trailer may be transported within the semi-trailer body.

### BRIEF DESCRIPTION OF THE DRAWINGS

Other benefits and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a representative flow chart of the steps in a method for assembling a semi-trailer according to an embodiment of the invention;

FIG. 2 shows a side view of a shipping container;

FIG. 3 shows a number of shipping containers of the type shown in FIG. 2 in a stacked arrangement;

FIG. 4 shows a side view of an assembled semi-trailer;

FIG. 5 shows a container chassis for transporting a semi-trailer body according to an embodiment of the invention;

FIG. 6 shows a running gear assembly attached to a semi-trailer body according to an embodiment of the invention;

FIG. 7A shows a kingpin assembly for attaching to a semi-trailer body according to an embodiment of the invention;

FIG. 7B shows a kingpin assembly for attaching to a semi-trailer body according to another embodiment of the invention;

FIG. 7C shows a kingpin assembly for attaching to a semi-trailer body according to another embodiment of the invention;

FIG. 8 shows a front view of a semi-trailer body according to an embodiment of the invention;

FIG. 9 shows a landing gear assembly for attaching to a semi-trailer body according to an embodiment of the invention;

FIG. 10 shows a rear view of a semi-trailer body according to an embodiment of the invention, including a rear under-ride guard for attachment to the semi-trailer body;

FIG. 11 shows rear marker lights for attachment to a semi-trailer body according to an embodiment of the invention; and

FIG. 12 shows a removable stacking frame for a semi-trailer body according to an embodiment of the invention.

### DETAILED DESCRIPTION OF THE DRAWINGS

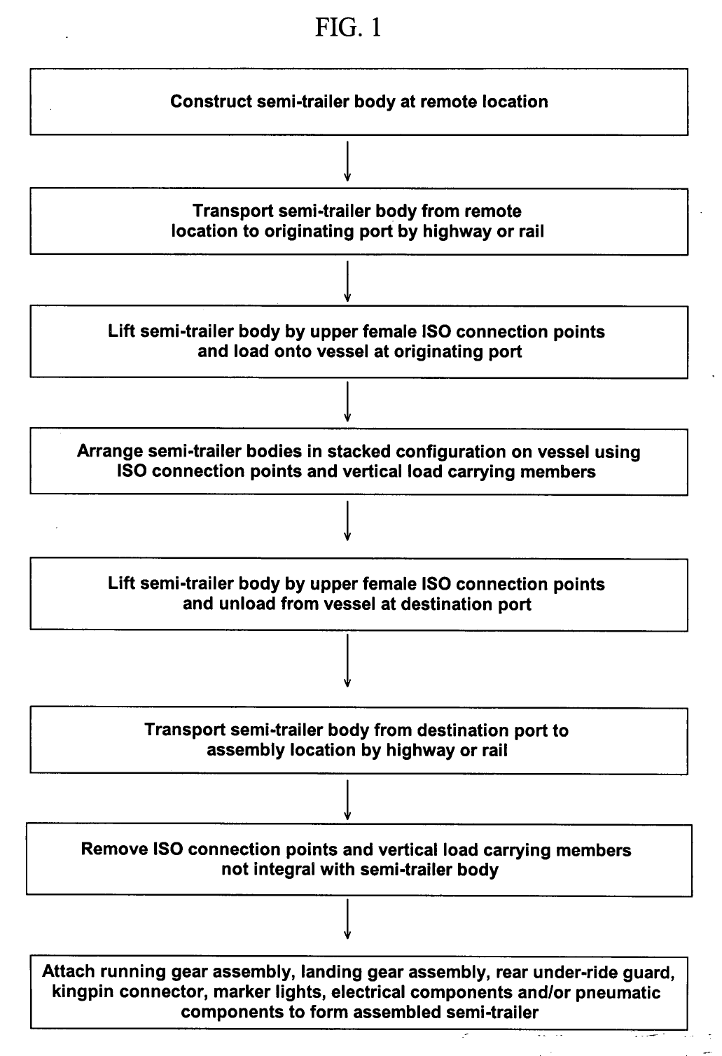

Referring now in detail to the drawings, FIG. 1 is a flow chart showing some exemplary steps of a method for assembling a semi-trailer according to an embodiment of the invention. A method for assembling a semi-trailer according to an embodiment of the invention may include the step of constructing or sourcing a semi-trailer kit or semi-trailer body at a remote location. Remote location refers to a location other then the location where final assembly of the semi-trailer will take place. Preferably, the semi-trailer kit or body is sourced from and/or manufactured at a location overseas from a final assembly location, resulting in a lower cost product. For example, in a method according to the invention, a semi-trailer kit or semi-trailer body may be constructed in China, and subsequently transported to the United States, Canada or Mexico for final assembly into a finished semi-trailer.

The semi trailer body is transported from the remote location to an originating port by highway or rail. Rail transport may be accomplished using suitable railway cars, for example railway cars used for transporting shipping containers. Multiple semi-trailer bodies according to embodiments of the invention may be arranged in a stacked configuration on the railway cars. Highway transport of the semi-trailer bodies may be accomplished using a flat bed truck or a container chassis, for example a container chassis as shown in FIG. 5.

The semi-trailer body is lifted onto a vessel at the originating port by lifting the semi-trailer body using a plurality of upper female ISO connection points. Preferably, the vessel is an ocean-going vessel capable of transporting multiple semi-trailer bodies at once, for example a container ship or barge.

A semi-trailer body according to an embodiment of the invention is adapted to be lifted and moved using equipment used to lift and move standard shipping containers, as shown for example in FIG. 3. Such equipment includes, for example, cranes, straddle carriers and the like. A semi-trailer body according to an embodiment of the invention is also adapted to be arranged in a stacked configuration on the vessel or other surface using the plurality of upper female ISO connection points and a plurality of vertical load carrying members.

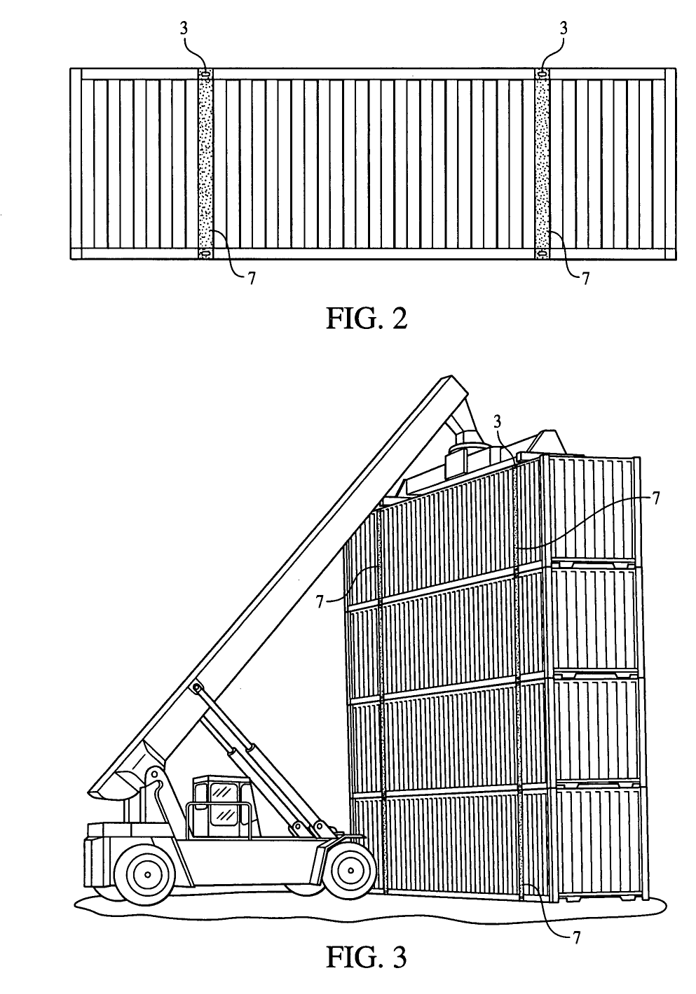

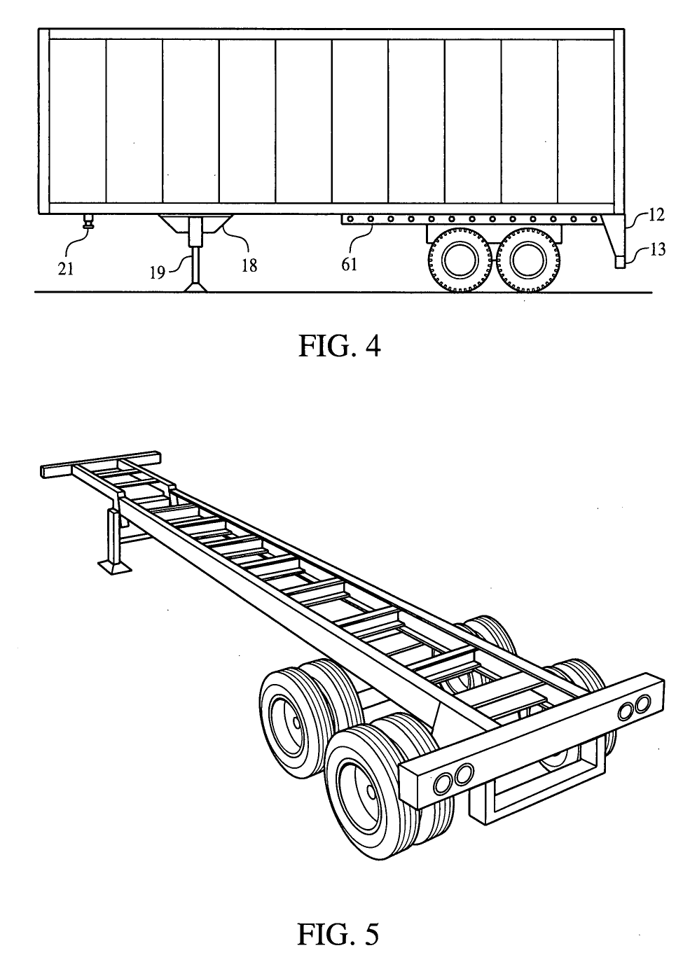

The plurality of upper female ISO connection points may be disposed on an upper portion of the semi-trailer body and may comprise upper female ISO connection points 3 as shown on the container in FIGS. 2 and 3. The plurality of vertical load carrying members may be in the form of stacking frame posts 7 as shown on the container in FIGS. 2 and 3.

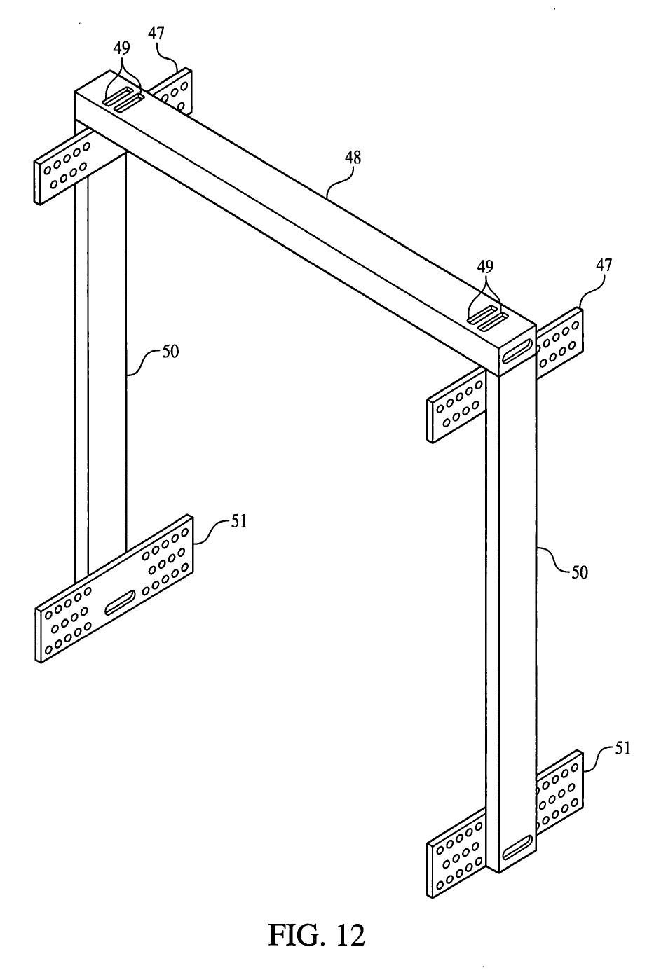

Alternatively, the upper female ISO connection points and vertical load carrying members may be arranged in an exterior stacking frame or “halo-style” stacking frame removably secured to an outer surface of the semi-trailer body. As shown in FIG. 12, such a stacking frame assembly may include upper mounting plates 47, an upper longitudinal header 48, upper female ISO connection points in the form of top pick castings 49, vertical stacking frame posts 50 and lower mounting plates 51. Such a stacking frame arrangement can be secured to the semi-trailer body when needed to lift and/or stack the semi-trailer body and subsequently removed during assembly of the finished semi-trailer.

The upper female ISO connection points and/or vertical load carrying members may also be incorporated into a stacking frame made integral with the semi-trailer body. For example, the upper female ISO connection points and/or vertical load carrying members may be formed as part of the semi-trailer body as in the container shown in FIG. 2. The upper female ISO connection points and/or vertical load carrying members may be integral with the wall and/or roof structure of the semi-trailer body.

The upper female ISO connection points and/or vertical load carrying members may also be incorporated into a stacking frame disposed inside the semi-trailer body. In this method, a plurality of openings are provided in a roof of the semi-trailer body so that the plurality of upper female ISO connection points project above a plane of the roof.

In particular, upper female ISO connection points are adapted to be coupled to various types of lifting apparatus used to lift containers, for example cranes, straddle carriers and the like. Preferably, the upper female ISO connection points associated with a semi-trailer body used in a method according to an embodiment of the invention are arranged and/or spaced apart in a manner similar to the arrangement and/or spacing of the connection points on a container so that the semi-trailer body is compatible with equipment used to manipulate containers.

The upper female ISO connection points may comprise upper castings and may be adapted to receive twist lock connectors or other types of couplings used to lift containers. Lower ISO connection points or floor castings may also be associated with a semi-trailer used in a method according to an embodiment of the invention. Such lower connection points or floor castings may be removable from the semi-trailer body and may be part of a transverse member aligned with a stacking frame. Alternatively, the lower connection points or floor castings may be permanent.

Once on board the vessel, preferably an international cargo ship or barge, the semi-trailer bodies may be arranged in a stacked fashion to permit economical transport. The semi-trailer bodies may be connected in the stack using conventional twist-lock connectors between the various upper and lower connection points provided in the semi-trailer bodies. For example, a twist-lock connector may be secured between an upper casting of a first semi-trailer body and a corresponding lower casting of a second semi-trailer body stacked above the first semi-trailer body. The vertical load carrying members associated with each semi-trailer body provide the required strength to permit stacking of the semi-trailer bodies

Once the vessel arrives at a destination port, the semi-trailer bodies are unloaded from the vessel by lifting the semi-trailer bodies using the plurality of upper female ISO connection points. This lifting is accomplished using equipment and methods used for shipping containers as previously described. The semi-trailer bodies may be transported from the destination port to an assembly location by rail or be highway, for example using a flatbed truck or container chassis as previously described.

One or more components of the various assemblies to be added to the semi-trailer body to produce an assembled semi-trailer, for example a running gear assembly, a landing gear assembly, a rear under-ride guard and/or a kingpin connector, may be loaded into the semi-trailer body prior to loading the semi-trailer body onto the vessel at the originating port. Prior to final assembly of the semi-trailer, any components loaded inside of the semi-trailer body are removed. This can be done at a loading dock prior to removal of the semi-trailer body from a supporting trailer or container chassis or after the semi-trailer body is placed on the ground. Any required components not loaded inside the semi-trailer body may be sourced independently, for example locally, and shipped separately to a location for assembly of the semi-trailer.

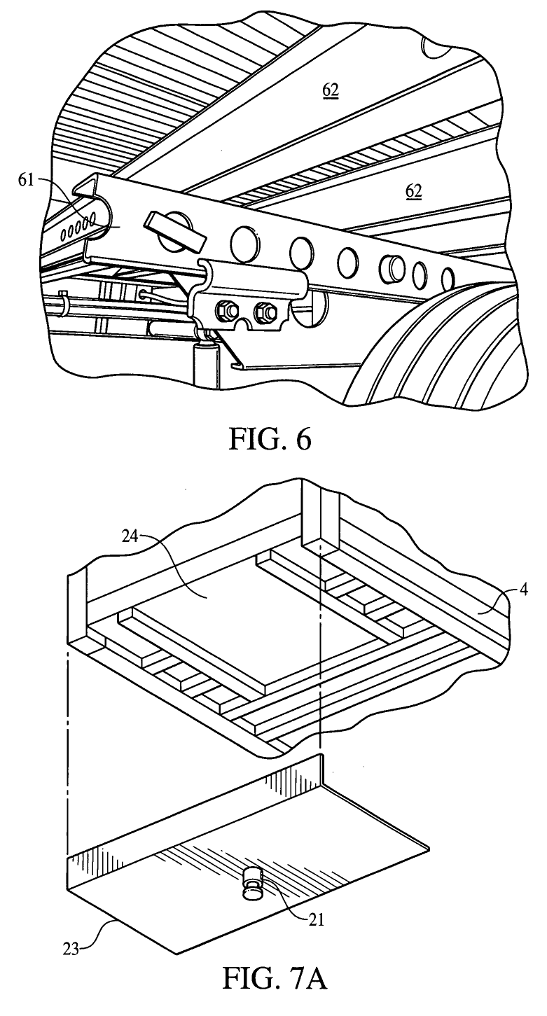

Various components and assemblies are added to the semi-trailer body to form an assembled semi-trailer. For example a running gear assembly as shown in FIG. 6 may be attached to an underside of the semi-trailer body. The running gear assembly may include, for example, wheels, tires, axles, brakes, suspension members and rails. The running gear assembly may include running gear rails 61 which are attached to the semi-trailer body, for example by securing the rails 61 to cross members 62 located on the floor of the semi-trailer body. The rails 61 for the running gear can also be provided as part of the semi-trailer body as transported on the vessel. The trailer suspension is attached to the rails 61. The running gear assembly may comprise a fixed location running gear or a sliding running gear as shown in FIG. 6, wherein the rail 61 comprises a slide rail. The sliding running gear has adjustable positions and may include a sliding tandem which locks into various positions along slide rail 61 using a spring loaded locking pin.

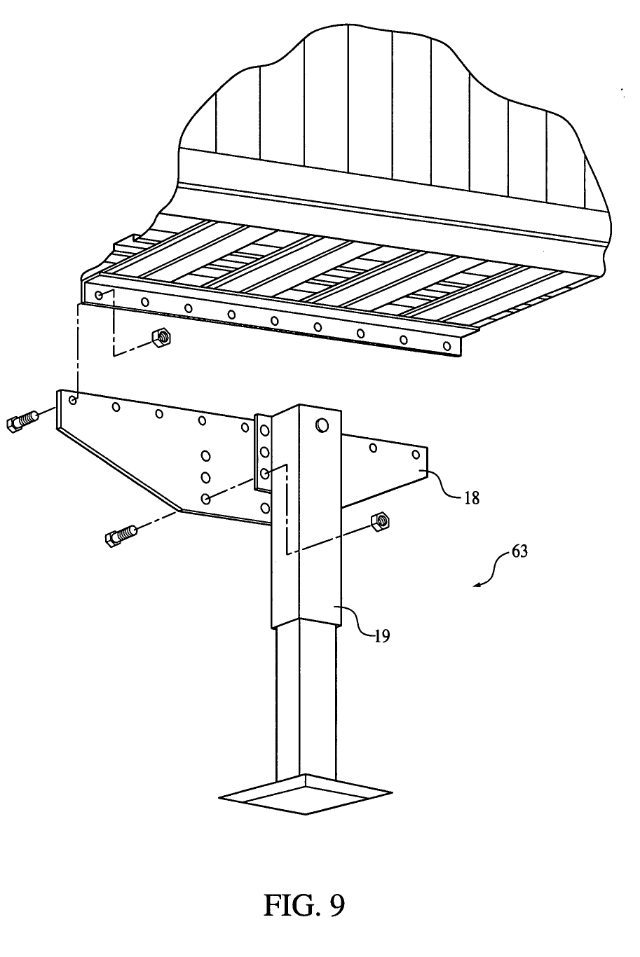

Additionally, a landing gear assembly 63 may be attached to the semi-trailer body. The landing gear assembly is used to support the semi-trailer when not coupled to a tractor. Landing gear assembly 63 may include landing gear mounting bracket 18 and landing gear leg 19, as shown for example in FIG. 9. The landing gear assembly may be bolted, welded or otherwise attached to an underside of the semi-trailer body.

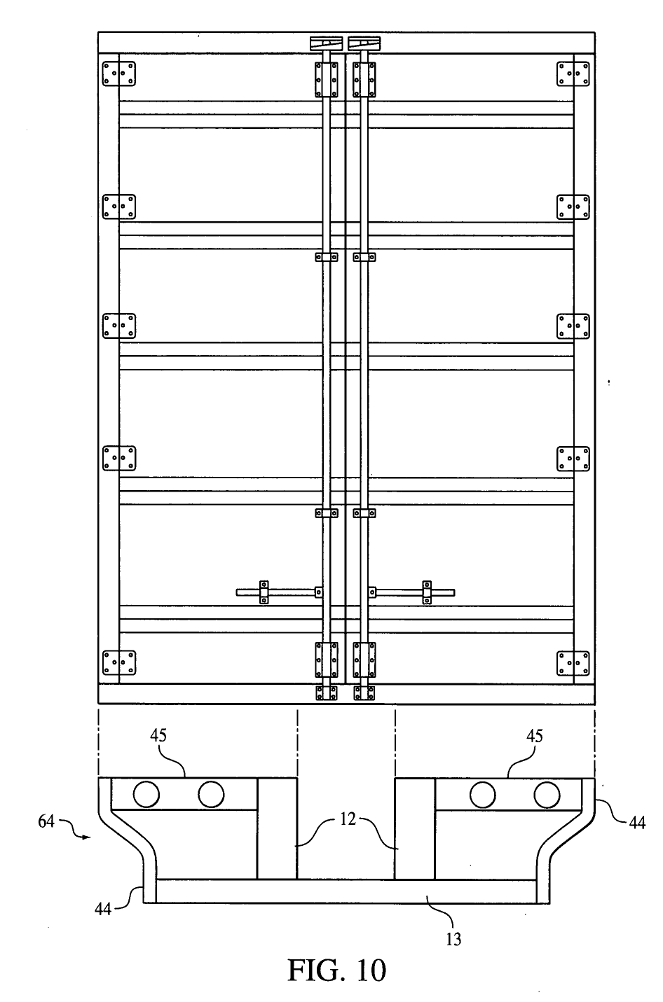

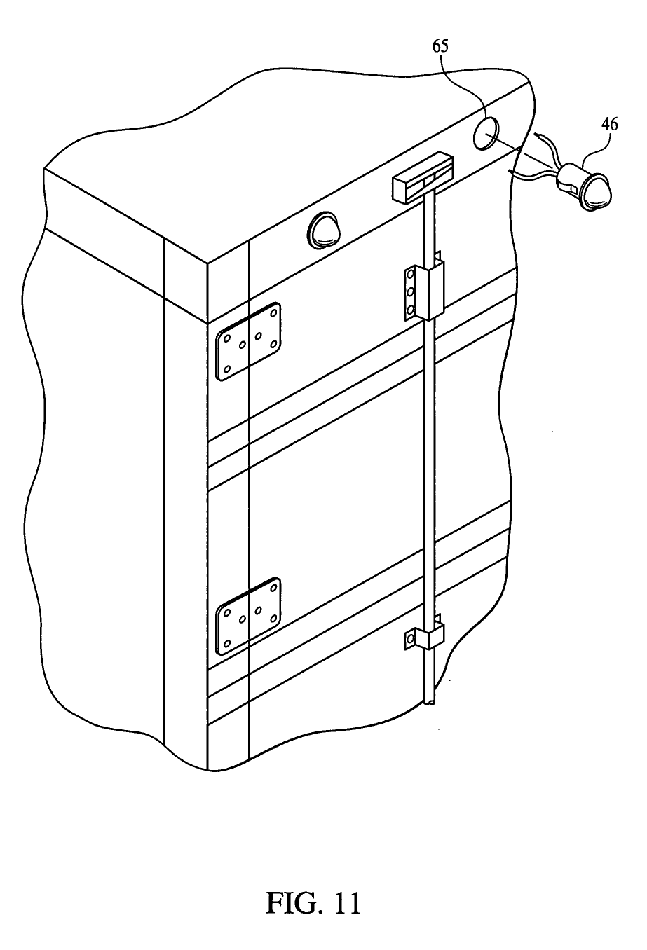

Additionally, a rear under-ride guard or assembly 64 may be attached to the semi-trailer body. The rear under-ride guard 64 is disposed on the rear portion of the semi-trailer and prevents cars or other vehicles from sliding under the trailer in the event of a rear end collision. The rear under-ride guard 64 may be bolted, welded or otherwise attached to the semi-trailer body. As shown in FIG. 10, rear under-ride guard 64 may include bumper uprights 12, bumper horizontal member 13, bumper outboards 44 and light boxes 45.

The semi-trailer body as constructed at or sourced from the remote location may include mounting locations for the various components to be added to complete the semi-trailer assembly, including the running gear assembly, the landing gear assembly, the rear under-ride guard, the kingpin connector and other assemblies. Hardware may also be provided along with the semi-trailer body for mounting the various components to the semi-trailer body.

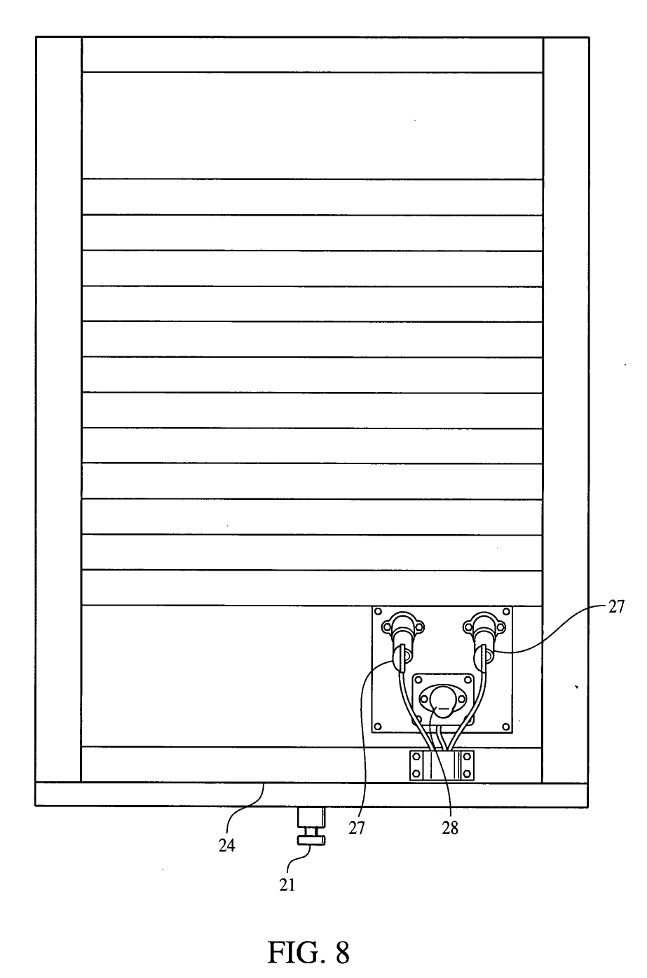

The semi-trailer body as constructed at or sourced from the remote location may include openings for marker lights, electrical wiring and pneumatic lines. FIG. 11 shows the installation of marker light 46 into opening 65 provided in the semi-trailer body. FIG. 8 shows an electrical connector 28, which may comprise a seven-way electrical connector. The electrical wiring is routed through openings provided in the semi-trailer body. Also shown are pneumatic lines 27 which are routed through openings in the semi-trailer body. Various conduits for electrical wiring and/or pneumatic lines may also be provided to facilitate installation of these components. In a further embodiment of the invention, electrical and/or pneumatic components could be included with the semi-trailer body which is transported on the vessel from the remote location. For example, the semi-trailer body could include wiring for a lighting system and/or pneumatic lines and components for a braking system.

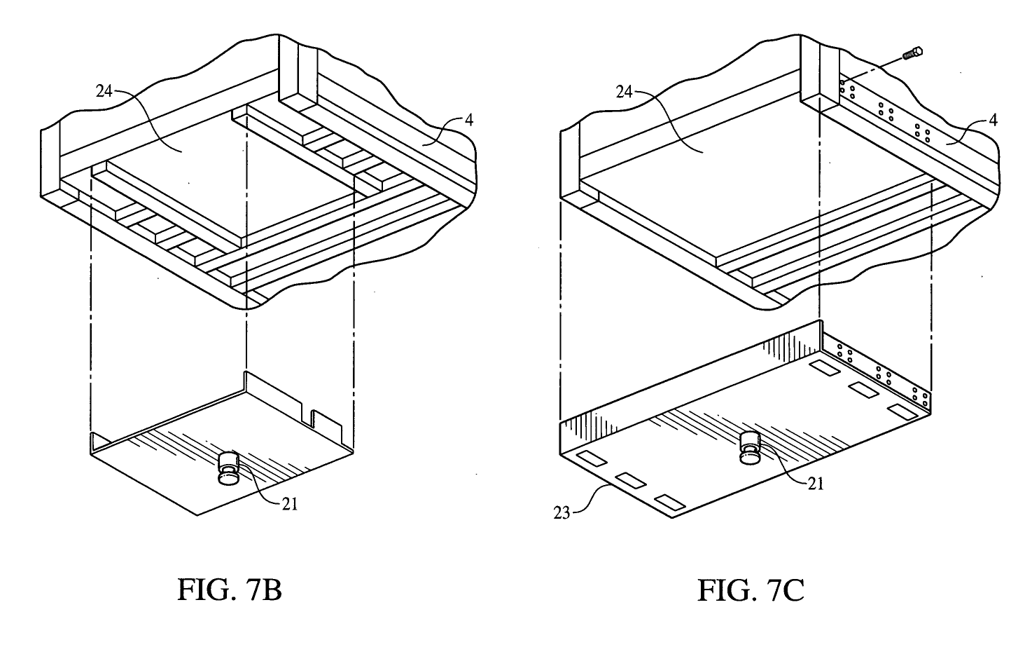

A kingpin connector may also be attached to the semi-trailer body to permit attachment of the trailer to a tractor. The kingpin connector may include a kingpin 21 and an upper coupler bottom plate 23. The kingpin connector may be attached to the semi-trailer body in a number of ways. For example, as shown in FIG. 7A, the kingpin connector may be fastened to a kingpin sub-frame provided on the semi-trailer body. As shown in FIG. 7B, the kingpin connector and a portion of a sub-frame may be fastened to a tunnel arrangement 24 provided on the semi-trailer body. Tunnel arrangement 24 is required if the semi-trailer body is to be transported using a container chassis, as shown for example in FIG. 5. As shown in FIG. 7C, this tunnel arrangement 24 may be removed and the kingpin connector attached in its place. In this embodiment, the kingpin connector may be fastened to a plurality of side rails 4 associated with the semi-trailer body.

Any of the plurality of upper female ISO connection points and the plurality of vertical load carrying members, for example the stacking frame members and/or castings, that are not integral with the semi-trailer body are preferably removed from the semi-trailer body. Additionally, the tunnel arrangement, if provided, may be removed from the semi-trailer body. The removed components may be disposed of or shipped back to the manufacturer for re-use. Any openings resulting from the removal of such components should be closed if such openings could provide an opportunity for leakage into the interior of the semi-trailer body.

Accordingly, while several embodiments of the present invention have been shown and described, it is obvious that many changes and modifications may be made thereunto without departing from the spirit and scope of the invention.

What is claimed is:

1. A method for assembling a semi-trailer, the method comprising the steps of:
a) constructing a semi-trailer body at a remote location;
b) transporting the semi trailer body from the remote location to an originating port by highway or rail;
c) loading the semi-trailer body onto a vessel at the originating port by lifting the semi-trailer body using a plurality of upper female ISO connection points;
d) arranging the semi-trailer body in a stacked configuration on the vessel using the plurality of upper female ISO connection points and a plurality of vertical load carrying members;
e) unloading the semi-trailer body from the vessel at a destination port by lifting the semi-trailer body using the plurality of upper female ISO connection points; and
f) attaching a running gear assembly, a landing gear assembly, and a rear under-ride guard to the semi-trailer body to form an assembled semi-trailer.

2. The method for assembling a semi-trailer according to claim 1, wherein the step of transporting the semi-trailer body from the remote location to the originating port comprises transporting the semi-trailer body on a flat bed truck.

3. The method for assembling a semi-trailer according to claim 1, wherein the step of transporting the semi-trailer body from the remote location to the originating port comprises transporting the semi-trailer body using a container chassis.

4. The method for assembling a semi-trailer according to claim 1, further comprising the step of transporting the semi-trailer body from the destination port to an assembly location by highway or rail.

5. The method for assembling a semi-trailer according to claim 4, wherein the step of transporting the semi-trailer body from the destination port to the assembly location comprises transporting the semi-trailer body on a flat bed truck.

6. The method for assembling a semi-trailer according to claim 4, wherein the step of transporting the semi-trailer body from the destination port to the assembly location comprises transporting the semi-trailer body using a container chassis.

7. The method for assembling a semi-trailer according to claim 1, wherein the step of constructing a semi-trailer body at a remote location further comprises providing a semi-trailer body having mounting locations for the running gear assembly, the landing gear assembly and the rear under-ride guard.

8. The method for assembling a semi-trailer according to claim 1, wherein the step of constructing a semi-trailer body at a remote location further comprises providing a semi-trailer body having openings for marker lights, electrical wiring and pneumatic lines.

9. The method for assembling a semi-trailer according to claim 1, wherein the step of constructing a semi-trailer body at a remote location further comprises providing a semi-trailer body having wiring for a lighting system.

10. The method for assembling a semi-trailer according to claim 1, wherein the step of constructing a semi-trailer body at a remote location further comprises providing a semi-trailer body having pneumatic components for a braking system.

11. The method for assembling a semi-trailer according to claim 1, further comprising the step of loading a component for one or more of the running gear assembly, the landing gear assembly, and the rear under-ride guard into the semi-trailer body prior to the step of loading the semi-trailer body onto the vessel at the originating port.

12. The method for assembling a semi-trailer according to claim 1, wherein the step of constructing a semi-trailer body at a remote location further comprises providing a semi-trailer body wherein the plurality of upper female ISO connection points and the plurality of vertical load carrying members are arranged in an exterior stacking frame removably secured to an outer surface of the semi-trailer body.

13. The method for assembling a semi-trailer according to claim 1, wherein the step of constructing a semi-trailer body at a remote location further comprises providing a semi-trailer body wherein the plurality of upper female ISO connection points are incorporated into a stacking frame made integral with the semi-trailer body.

14. The method for assembling a semi-trailer according to claim 1, wherein the step of constructing a semi-trailer body at a remote location further comprises providing a semi-trailer body wherein the plurality of upper female ISO connection points are incorporated into a stacking frame disposed inside the semi-trailer body and a plurality of openings are provided in a roof of the semi-trailer body so that the plurality of upper female ISO connection points project above a plane of the roof.

15. The method for assembling a semi-trailer according to claim 1, further comprising attaching a kingpin connector to the semi-trailer body by fastening the kingpin connector to a kingpin sub-frame provided on the semi-trailer body.

16. The method for assembling a semi-trailer according to claim 1, further comprising attaching a kingpin connector and a portion of a sub-frame to a tunnel arrangement provided on the semi-trailer body.

17. The method for assembling a semi-trailer according to claim 1, further comprising removing a tunnel arrangement from the semi-trailer body and attaching a kingpin connector in place of the tunnel arrangement by fastening the kingpin connector to a plurality of side rails of the semi-trailer body.

18. The method for assembling a semi-trailer according to claim 1, further comprising the step of removing any of the plurality of upper female ISO connection points and the plurality of vertical load carrying members that are not integral with the semi-trailer body.

19. A method for assembling a semi-trailer, the method comprising the steps of:
a) sourcing a semi-trailer kit from a remote location, the semi-trailer kit comprising a semi-trailer body, a plurality of upper female ISO connection points and a plurality of vertical load carrying members;
b) lifting the semi-trailer body from a vessel at a destination port using the plurality of upper female ISO connection points; and
c) attaching a running gear assembly, a landing gear assembly and a rear under-ride guard to the semi-trailer body to form an assembled semi-trailer.

20. The method for assembling a semi-trailer according to claim 19, further comprising the step of transporting the semi-trailer body from the destination port to an assembly location by highway or rail.

21. The method for assembling a semi-trailer according to claim 20, wherein the step of transporting the semi-trailer body from the destination port to the assembly location comprises transporting the semi-trailer body on a flat bed truck.

22. The method for assembling a semi-trailer according to claim 20, wherein the step of transporting the semi-trailer body from the destination port to the assembly location comprises transporting the semi-trailer body using a container chassis.

23. The method for assembling a semi-trailer according to claim 19, wherein the step of sourcing the semi-trailer kit at a remote location further comprises sourcing a semi-trailer body having mounting locations for the running gear assembly, the landing gear assembly and the rear under-ride guard.

24. The method for assembling a semi-trailer according to claim 19, wherein the step of sourcing a semi-trailer kit at a remote location further comprises sourcing a semi-trailer body having openings for marker lights, electrical wiring and pneumatic lines.

25. The method for assembling a semi-trailer according to claim 19, wherein the step of sourcing a semi-trailer kit at a remote location further comprises sourcing a semi-trailer body having wiring for a lighting system.

26. The method for assembling a semi-trailer according to claim 19, wherein the step of sourcing a semi-trailer kit at a remote location further comprises sourcing a semi-trailer body having pneumatic components for a braking system.

27. The method for assembling a semi-trailer according to claim 19, further comprising the step of loading a component for one or more of the running gear assembly, the landing gear assembly and the rear under-ride guard into the semi-trailer body prior to the step of lifting the semi-trailer body from the vessel at the destination port.

28. The method for assembling a semi-trailer according to claim 19, wherein the step of sourcing a semi-trailer kit at a remote location further comprises sourcing a semi-trailer body wherein the plurality of upper female ISO connection points and the plurality of vertical load carrying members are arranged in an exterior stacking frame removably secured to an outer surface of the semi-trailer body.

29. The method for assembling a semi-trailer according to claim 1, wherein the step of sourcing a semi-trailer kit at a remote location further comprises sourcing a semi-trailer body wherein the plurality of upper female ISO connection points are incorporated into a stacking frame made integral with the semi-trailer body.

30. The method for assembling a semi-trailer according to claim 19, wherein the step of sourcing a semi-trailer kit at a remote location further comprises sourcing a semi-trailer body wherein the plurality of upper female ISO connection points are incorporated into a stacking frame disposed inside the semi-trailer body and a plurality of openings are provided in a roof of the semi-trailer body so that the plurality of upper female ISO connection points project above a plane of the roof.

31. The method for assembling a semi-trailer according to claim 19, further comprising attaching a kingpin connector to the semi-trailer body by fastening the kingpin connector to a kingpin sub-frame provided on the semi-trailer body.

32. The method for assembling a semi-trailer according to claim 19, further comprising attaching a kingpin connector and a portion of a sub-frame to a tunnel arrangement provided on the semi-trailer body.

33. The method for assembling a semi-trailer according to claim 19, further comprising removing a tunnel arrangement from the semi-trailer body and attaching a kingpin connector in place of the tunnel arrangement by fastening the kingpin connector to a side rail of the semi-trailer body.

34. The method for assembling a semi-trailer according to claim 19, further comprising the step of removing any of the plurality of upper female ISO connection points and the plurality of vertical load carrying members that are not integral with the semi-trailer body.
